(19) United States
(12) Patent Application Publication
(10) Pub. No.: US 2025/0348158 A1
(43) Pub. Date: Nov. 13, 2025

(54) WRITING DEVICE, DISPLAY DEVICE, AND COMMUNICATION SYSTEM

(71) Applicant: Naoyuki ISHIKAWA, Kanagawa (JP)

(72) Inventor: Naoyuki ISHIKAWA, Kanagawa (JP)

(73) Assignee: Ricoh Company, Ltd., Tokyo (JP)

(21) Appl. No.: 19/197,244

(22) Filed: May 2, 2025

(30) Foreign Application Priority Data
May 8, 2024 (JP) 2024-075882
Mar. 14, 2025 (JP) 2025-041669

(51) Int. Cl. G06F 3/0354; G06F 3/041

(52) U.S. Cl. CPC G06F 3/03545; G06F 3/0412; G06F 3/04162

(57) ABSTRACT

A writing device includes a movable portion having a contact portion and being configured to be movable in advancing and retracting directions to be retracted when the contact portion comes into contact with a contact target portion; a holding portion configured to hold the movable portion; and an elastic portion provided on a side opposite from a contact portion side of the movable portion in the advancing and retracting directions. The elastic portion includes a first elastic body and a second elastic body that are each elastically deformed by retraction of the movable portion to reduce a thickness in the advancing and retracting directions. The first elastic body and the second elastic body are provided adjacent to each other in this order with respect to the movable portion, and the first elastic body is an elastic body having stiffness lower than stiffness of the second elastic body.

### CROSS-REFERENCE TO RELATED APPLICATIONS

The present application is based on and claims priority under 35 U.S.C. § 119 to Japanese Patent Application No. 2024-075882, filed on May 8, 2024, and Japanese Patent Application No. 2025-041669, filed on Mar. 14, 2025, the entire contents of which are hereby incorporated by reference.

### BACKGROUND OF THE INVENTION

### 1. Field of the Invention

The present disclosure relates to a writing device, a display device, and a communication system.

### 2. Description of the Related Art

In recent years, there is a display device including an electronic blackboard that enables writing by a writing device (hereinafter referred to as a pen-type input device). In such an electronic blackboard, when a contact portion of the pen-type input device comes into contact with a display face of the electronic blackboard, the electronic blackboard detects the contact position on the display face and fills in the position, thereby implementing writing on the display face by the pen-type input device.

For example, a pen-type input device disclosed in Patent Document 1 (Japanese Patent No. 6127548) includes a penpoint movable portion provided so as to advance and retract in an axial direction, a movable segment pressed by retracting movement of the penpoint movable portion, a switch pressed by the movable segment, a spring member that returns the movable segment to an OFF position, and the like. When an operator brings the penpoint movable portion into contact with the display portion, the penpoint movable portion retracts to press a movable piece, thereby turning on the switch. As a result, a wireless signal is transmitted to the main body of the electronic blackboard, and writing is performed at the position pressed on the display portion by the penpoint movable portion.

In such a pen-type input device, a writing sound (contact sound) when the contact portion comes into contact with the display portion may be large. In order to handle this point, when the contact portion comes into contact with the display portion, the writing sound can be reduced by providing a soft cushioning material. However, when a soft cushioning material is used, it is necessary to provide a large thickness of the contact portion in order to reduce the writing sound. This causes the stroke of the contact portion in the advancing and retracting directions to increase so that the writability of the pen-type input device deteriorates. When a hard cushioning material is used, the writability is improved, but the contact sound may fail to be sufficiently reduced. In addition, in order to reduce the writing sound, there is a countermeasure method of covering the tip of the pen-type input device with a soft cushioning material, but the feel of the pen-type input device changes when writing due to changes in the material of the tip or the like.

According to an aspect of the present disclosure, it is desirable to provide a pen-type input device capable of reducing writing sound.

### SUMMARY OF THE INVENTION

According to an aspect of the present disclosure, a writing device is provided. The writing device includes:
a movable portion having a contact portion, the movable portion being configured to be movable in advancing and retracting directions so as to be retracted when the contact portion comes into contact with a contact target portion;
a holding portion configured to hold the movable portion; and
an elastic portion provided on a side opposite from a contact portion side of the movable portion in the advancing and retracting directions,
wherein the elastic portion includes a first elastic body and a second elastic body, the first elastic body and the second elastic body each being elastically deformed by retraction of the movable portion to reduce a thickness in the advancing and retracting directions,
wherein the first elastic body and the second elastic body are provided adjacent to each other in this order with respect to the movable portion, and
wherein the first elastic body is an elastic body having stiffness lower than stiffness of the second elastic body.

### BRIEF DESCRIPTION OF THE DRAWINGS

FIG. 1 is a schematic configuration diagram illustrating a display device including a pen-type input device according to an embodiment of the present disclosure;

FIG. 2 is a functional block diagram of the display device;

FIG. 3 is a cross-sectional view illustrating a penpoint side of the pen-type input device;

FIG. 4 is a cross-sectional view illustrating a state in which a switch is pressed in the pen-type input device of FIG. 3;

FIG. 5 is a cross-sectional view illustrating a pen-type input device according to a second embodiment;

FIG. 6 is a cross-sectional view illustrating a pen-type input device according to a third embodiment;

FIG. 7 is a cross-sectional view illustrating a pen-type input device according to a fourth embodiment; and

FIG. 8 is a schematic diagram illustrating an educational system to which the pen-type input device is applied.

### DETAILED DESCRIPTION OF THE PREFERRED EMBODIMENTS

According to aspects of the present disclosure, it is desirable to provide a writing device, a display device, and a communication system capable of reducing writing sound.

Hereinafter, embodiments of the present disclosure will be described with reference to the drawings. In the drawings, the same or corresponding parts are denoted by the same reference numerals, and the redundant description will be simplified or omitted as appropriate.

### Pen-Type Input Device According To First Embodiment

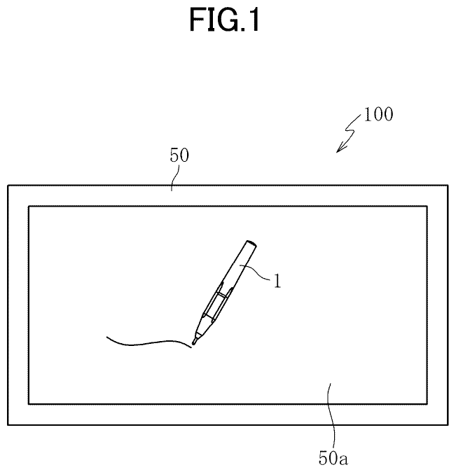

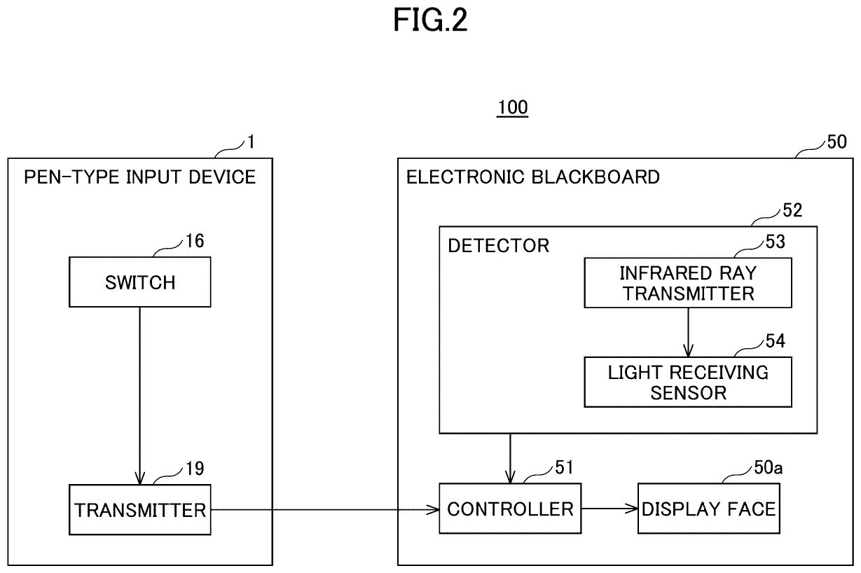

FIG. 1 is a schematic configuration diagram illustrating a display device including a pen-type input device according to an embodiment of the invention. FIG. 2 is a functional block diagram of the display device.

As illustrated in FIG. 1, a display device 100 includes a pen-type input device 1 as a writing device and an electronic blackboard 50. When the tip of the pen-type input device comes into contact with a display face 50a of the electronic blackboard 50, the electronic blackboard 50 recognizes the contact position on the display face 50a, and the contact position is filled in. This enables an operator to form a desired image on the display face 50a by the pen-type input device 1. The display face 50a of the electronic blackboard 50 can share the image with a remote place via the Internet. The display face 50a of the present embodiment is made of glass. The display device of the present disclosure is provided with a contact target portion that is contacted by the pen-type input device. As one aspect of the contact target portion, there is a display portion that displays an image on a portion where the pen-type input device comes in contact. The electronic blackboard 50 of the present embodiment is a specific example of the display portion.

As illustrated in FIG. 2, the pen-type input device 1 comes into contact with the display face 50a, whereby the switch 16 as a pressing portion is pressed. Accordingly, the transmitter 19 transmits a wireless signal to the controller 51 of the electronic blackboard 50.

The electronic blackboard 50 includes a controller 51 and a detector 52. The detector 52 includes an infrared ray transmitter 53 and a plurality of light receiving sensors 54. The infrared ray transmitter 53 scans infrared rays in a grid pattern from one side to the other side in the vertical direction at each position in the horizontal direction in FIG. 1, and from one side to the other side in the horizontal direction at each position in the vertical direction. The light receiving sensors 54 are disposed along, for example, the display face 50a, and receive the infrared rays transmitted by the infrared ray transmitter 53. However, the detector 52 does not necessarily need to have a configuration (infrared detection method) of scanning infrared rays, and an appropriate configuration capable of detecting a position of the pen-type input device 1, such as a pressure sensitive system, a capacitance system, or an electromagnetic induction system, can be adopted. The transmission directions of the infrared rays and the arrangement of the light receiving sensors 54 are not limited to the above-described examples, and appropriate directions and arrangement that can detect a contact position of the pen-type input device 1 with respect to the display face 50a can be selected.

When the tip of the pen-type input device 1 contacts any position on the display face 50a, the transmission of the infrared rays is blocked at that position. As a result, the infrared rays do not reach the plurality of light receiving sensors 54, and the light receiving sensors 54 change from the detection state to the non-detection state. The controller 51 receives the detection results of the light receiving sensors 54. The controller 51 receives signals transmitted from the transmitter 19 of the pen-type input device 1. Thus, the controller 51 detects a position on the display face 50a with which the tip of the pen-type input device 1 is in contact, and writes an image (displays an image) at the position on the display face 50a.

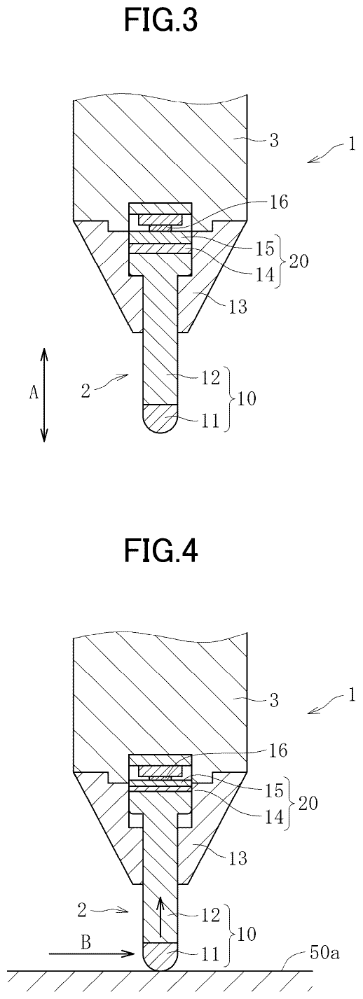

Next, a more detailed configuration of the pen-type input device 1 will be described with reference to a cross-sectional view of FIG. 3.

As illustrated in FIG. 3, the pen-type input device 1 includes a penpoint portion 2 and a penpoint holder 3. The penpoint portion 2 includes a movable portion 10, a movable portion holder 13 as a holder, an elastic portion 20, a switch 16, and the like. The elastic portion 20 includes a first cushioning material 14 as a first elastic body and a second cushioning material 15 as a second elastic body. The movable portion 10 includes a contact member 11 as a contact portion, and a contact member holder 12. The movable portion holder 13 and the penpoint holder 3 may be integrated to hold the movable portion 10. The movable portion 10 may have an integral structure of the contact member 11 and the contact member holder 12. That is, the movable portion 10 may be configured to move when the pen-type input device 1 contacts the display face 50a. The elastic portion 20 is provided adjacent to the movable portion 10 in the vertical direction in FIG. 3, on the side opposite from the contact member 11. The tip portion (the lower portion in FIG. 3) of the contact member 11 is a contact portion that contacts the contact target portion.

The movable portion holder 13 holds the movable portion 10 so as to advance and retract in directions of the double-headed arrow A in FIG. 3. In the directions of the double-headed arrow A, the tip side of the pen-type input device 1, which is the lower side in FIG. 3, is the advancing direction of the movable portion 10. The upward direction in FIG. 3, which is the opposite direction, is the retracting direction of the movable portion 10. Hereinafter, the directions of the double-headed arrow A in FIG. 3 are simply referred to as advancing and retracting directions, the downward direction is simply referred to as an advancing direction, the downward direction side is simply referred to as an advancing side, the upward direction in FIG. 3 is simply referred to as a retracting direction, and the upward direction side is simply referred to as a retracting side.

In order to reduce scratches and wear of the display face 50a (see FIG. 1), the contact member 11, which is the tip portion of the movable portion 10, is made of a material having stiffness lower than that of the display face 50a. The contact member 11 is made of, for example, resin, and the contact member holder 12 is made of a metal material such as aluminum. However, the movable portion 10 including the contact member 11 and the contact member holder 12 may be made of the same material. The contact member 11 is a tip portion of the pen-type input device 1 in the advancing direction.

The first cushioning material 14 and the second cushioning material 15 are p provided on the retracting side from the movable portion 10. More specifically, the second cushioning material 15 is provided on the retracting side from the first cushioning material 14, and the first cushioning material 14 is provided in contact with an end portion of the movable portion 10 on the retracting side. The first cushioning material 14 and the second cushioning material 15 are provided adjacent to each other. The first cushioning material 14 is made of a material having stiffness lower than that of the second cushioning material 15. As an example, the first cushioning material 14 is made of sponge, and the second cushioning material 15 is made of rubber. The first cushioning material 14 is provided so that the first cushioning material 14 has a smaller thickness in the advancing and retracting directions than the second cushioning material 15. As an example, the first cushioning material 14 has a thickness of about 0.5 to 1.0 mm and the sponge stiffness of 10 to 20, and the second cushioning material 15 has a thickness of 1.5 to 2.5 mm, preferably about 2.0 mm, and the rubber stiffness of 50 to 60. When the first cushioning material 14 is made of rubber, the rubber stiffness may be 5 to 15, preferably about 10.

As the stiffness, the rubber stiffness may be measured by a durometer by a method in accordance with JIS K 6253 (2012), for example. The sponge stiffness may be measured by a durometer by a method in accordance with JIS K 7312 (1996), for example. The stiffness of other materials can be measured by the methods described in JIS as appropriate. Alternatively, the cushioning materials having the same thickness may be placed on a horizontal plane, and the same pressure (e.g., a pressure applied to the cushioning material by the operator when writing) may be applied to the movable portion perpendicularly to the horizontal plane, to measure the displacement amount (compression amount) in the thickness direction. The one of which the displacement amount is larger may be defined as a cushioning material having lower stiffness.

The first cushioning material 14 and the second cushioning material 15 have elasticity. The first cushioning material 14 and the second cushioning material 15 are elastically deformed by being pressed by the movable portion 10, and the thicknesses in the advancing and retracting directions of the first cushioning material 14 and the second cushioning material 15 are reduced. In particular, since the first cushioning material 14 has lower stiffness than the second cushioning material 15, the first cushioning material 14 is preferentially compressed. Then, when the first cushioning material 14 is sufficiently compressed, the second cushioning material is deformed next.

A specific calculation example of the deformation of the second cushioning material 15 in the case of using the above stiffness will be described. When the cushioning material has a cylindrical shape with a radius d (mm) and a height h (mm), the pressure receiving area AL (mm²) can be expressed by the following Equation (1). The pressure receiving area is the total area that receives the load, and is the area of a circle in the case of a cylindrical shape.

AL=π×(d/2)² (1)

When the load applied during writing is W (N), the deflection amount δ (mm), and the apparent Young's modulus Eap (Mpa), the static spring coefficient Ks of the rubber can be expressed by the following Equation (2).

Ks=W/δ=Eap×AL/h (2)

Therefore, from Equation (2), the deflection amount δ can be expressed by the following Equation (3).

δ=W×h/(Eap×AL) (3)

When the static shear modulus is G (Mpa) and the shape factor is S, the apparent Young's modulus Eap is can be expressed by the following Equation (4) because of a cylindrical shape.

Eap=G×(3+4.94×S²) (4)

The shape factor S of the rubber can be obtained as a value obtained by dividing the pressure receiving area by the free area. The free area is the total area of a portion that can be deformed under load. In the case of a cylindrical shape, the area of the side surface is used. Therefore, the shape factor S can be expressed by the following Equation (5) using Equation (1).

S=(π×(d/2)²)/πdh=d/4h (5)

From the above equations (1), (3), (4), and (5), the deflection amount δ can be expressed by the following Equation (6).

δ=W×h/(G×(3+4.94×(d/4h)²)×π×(d/2)²) (6)

Here, when the radius d (mm) is 5 mm, the height h (mm) is 2 mm, the load W (N) applied to the movable portion 10 during writing is 5 N at the maximum, and the static (Mpa) in the case of the second shear modulus G cushioning material 15 having the rubber stiffness of 50 to 60 is about 1, the deflection amount δ can be obtained as about 0.103 (mm) from Equation (6). Therefore, the displacement amount of the second cushioning material 15 having the stiffness described above is about 0.1 mm. When the first cushioning material 14 has the above-described stiffness relationship, the thickness of the first cushioning material 14 is in a range of about half to ⅕ of the thickness of the second cushioning material 15, and thus the displacement amount of the first cushioning material 14 is about 0.2 mm to 0.5 mm. Therefore, the displacement amount of the movable portion 10 is about 0.3 mm to 0.6 mm, and it is possible to reduce the writing sound while reducing an adverse effect on the writability.

As illustrated in FIG. 4, the infrared ray B scanning the display face 50a is blocked by the contact member 11 contacting the display face 50a. In this case, the contact member 11 is pressed in the retracting direction by the writing force of the operator, and the end portion of the contact member holder 12 on the retracting side presses the first cushioning material 14. As a result, the first cushioning material 14 and the second cushioning material 15 are compressed, and the switch 16 is pressed and turned on. As a result, a wireless signal is transmitted from the transmitter 19 of the pen-type input device 1 to the controller 51 of the electronic blackboard 50 (see FIG. 2). After writing, the contact of the contact member 11 with the display face 50a is released, so that the first cushioning material 14 and the second cushioning material 15 are elastically restored to the state illustrated in FIG. 3.

In the present embodiment, when the contact member 11 comes into contact with the display face 50a as described above, that is, when the operator writes on the electronic blackboard, the f first cushioning material 14 having low stiffness is first compressed by the movement of the movable portion 10 in the retracting direction due to the instantaneous impact. Thereafter, the second cushioning material 15 having a high stiffness is compressed and the switch 16 is pressed. With such a configuration, both excellent writability and reduction in writing sound of the pen-type input device 1 can be achieved. That is, in the phase where the first cushioning material 14 having lower stiffness is compressed, the compression amount of the first cushioning material 14 in the thickness direction with respect to the pressing force, that is, the retraction amount of the movable portion 10, is increased, and the contact sound caused by the contact of the contact member 11 with the display face 50a can be reduced. After the first cushioning material 14 is compressed, the second cushioning material 15 having a high stiffness is compressed, but the compression amount with respect to the pressing force is small. That is, the stroke amount of the movable portion 10 in the retracting direction can be prevented from becoming too large, and excellent writability can be achieved. In particular, the writability is further improved by making the thickness of the first cushioning material 14 having low stiffness in the advancing and retracting directions smaller than the thickness of the second cushioning material 15 having a high stiffness. Further, unlike the case where the contact member 11 that contacts the display face 50a is covered with a cushioning material to reduce the contact sound, there is no required change in materials of the display face 50a and the contact member 11. Therefore, it is possible to achieve excellent writability without adversely affecting the excellent writability of the pen-type input device 1.

In the case of a pen-type input device provided with only a hard cushioning material, unlike the present embodiment, the retraction amount of the movable portion with respect to the pressing force applied to the pen-type input device by the operator is small, and the writing sound becomes loud. When the writing sound of the pen-type input device is loud, for example, and when the content of the display portion is shared in a web conference, the microphone picks up the writing sound, which interferes with the conversation in the conference.

Conversely, in the case of a pen-type input device provided with only a soft cushioning material, when the thickness of the cushioning material is small, the cushioning material is compressed quickly, and the movable portion 10 collides with the switch 16 with great force via the cushioning material. Therefore, it appears difficult to prevent the writing sound from becoming loud. That is, in order to reduce the writing a soft sound, it appears necessary to provide cushioning material having a large thickness. However, in this case, the compression amount of the cushioning material increases, and the retraction amount of the movable portion also increases. When the retraction amount of the movable portion is too large, the time difference between the time point at which the operator brings the penpoint into contact with the display portion and the time point at which the switch is pressed becomes large, which may cause the writability of the pen-type input device to deteriorate.

In the present embodiment, by providing two cushioning materials having different stiffnesses, both excellent writability and reduction in writing sound can be achieved. When another member having stiffness higher than that of the second cushioning material 15 is provided between the first and the second cushioning materials, due to the fact that the first cushioning material 14 that comes into contact with the movable portion 10 is thin, the writing sound is increased by the contact between the movable portion 10 and the other member even through the first cushioning material 14, compared to a case where the other member is not interposed between the first and the second cushioning materials. However, in the present embodiment, the writing sound can be reduced by providing the first and the second cushioning materials adjacent to each other. Note that another member such as a sheet material that has stiffness lower than that of the second cushioning material 15 and hardly affects the writing sound may be interposed between the first and the second cushioning materials. In this case, the same effects as those of the above embodiment can be obtained.

Unlike the present embodiment, the movable portion may be configured to be movable in the advancing and retracting directions by a spring. However, in this case, the retraction amount of the movable portion becomes large, and the writability may deteriorate. According to the configuration of the present embodiment in which the movable portion is retracted by elastically deforming the cushioning materials, the retraction amount of the movable portion can be reduced, and excellent writability of the pen-type input device can be achieved.

In the present embodiment, the first cushioning material 14 having low stiffness is provided on the advancing side (the contact member 11 side) in the advancing and retracting directions with respect to the second cushioning material 15, and thus the first cushioning material 14 can be preferentially compressed when the movable portion 10 comes into contact with the first cushioning material 14. This makes it possible to reduce the writing sound more effectively.

In particular, in the present embodiment, the thickness of the first cushioning material 14 having low stiffness in the advancing and retracting directions is set to be smaller than the thickness of the second cushioning material 15 in the advancing and retracting directions. This makes it possible to reduce the stroke amount of the movable portion 10 in the advancing and retracting directions, and to particularly improve the writability of the pen-type input device. The thickness described here is a thickness in a state where the movable portion 10 is not retracted, that is, a state where each cushioning material is not compressed.

Next, a modification of the pen-type input device will be described.

### Second Embodiment

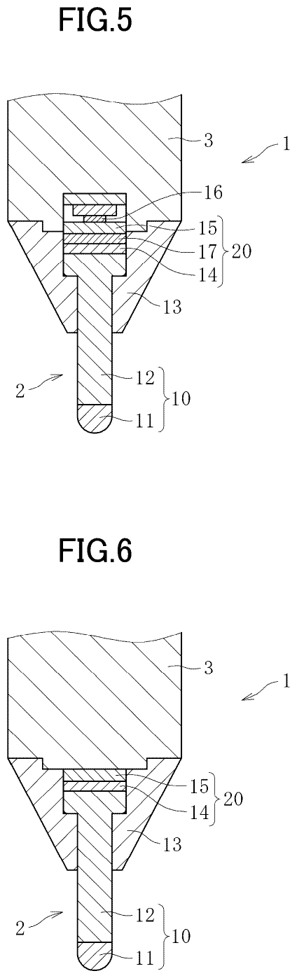

In the above description, the pen-type input device including only two cushioning materials is illustrated, but three or more cushioning materials may be included. For example, in the pen-type input device 1 illustrated in FIG. 5, the elastic portion 20 includes a third cushioning material 17 as another elastic body in addition to the first cushioning material 14 and the second cushioning material 15. The third cushioning material 17 is provided between the first cushioning material 14 and the second cushioning material 15, and has stiffness higher than that of the first cushioning material 14 and lower than that of the second cushioning material 15. That is, the cushioning materials are arranged in order of increasing stiffness toward the retracting direction. The cushioning materials are provided adjacent to each other. In the present embodiment, although the case where only one third cushioning material 17, which is an example of another elastic body, is provided has been described, a plurality of other elastic bodies may be provided between the first elastic body and the second elastic body, and the stiffnesses of the elastic bodies may be sequentially increased in the retracting direction.

By providing more types of cushioning materials as in the present embodiment, both the effects of the writability and reduction in writing sound can be achieved more favorably. That is, in the case of the hard cushioning material as described above, the stroke of the movable portion 10 in the advancing and retracting directions can be reduced to improve the writability, but the writing sound may undesirably increase. Conversely, in the case of a soft cushioning material, the writing sound can be reduced, but the stroke of the movable portion 10 in the advancing and retracting directions may undesirably become large and the writability may deteriorate. Therefore, by providing more types of cushioning materials, it is possible to adjust the balance between the effects of writability and reduction in writing sound more finely. For example, even in a case where the thickness of the first cushioning material 14 is increased by the thickness of the third cushioning material 17 illustrated in FIG. 5, failing to obtain excellent writability, or the thickness of the second cushioning material 15 is increased by the thickness of the third cushioning material 17, resulting in increase in writing sound, both excellent writability and reduction in writing sound can be achieved by providing the third cushioning material 17.

### Third Embodiment

In the above description, the pen-type input device including the pressing portion has been illustrated, but the pen-type input device of the present disclosure is not limited to the above-described example. For example, the pen-type input device 1 illustrated in FIG. 6 does not include the switch 16 as the pressing portion, unlike the pen-type input device 1 illustrated in FIG. 3. Unlike the above-described embodiment, in the display device including the pen-type input device 1 of the present embodiment, a signal is not transmitted from the pen-type input device 1 to the electronic blackboard, and the controller of the electronic blackboard writes on the display face only by physically blocking the infrared rays that the pen-type input device 1 scans on the display portion.

Also, in the pen-type input device 1 of the present embodiment, the writing sound increases when only the hard cushioning material is provided, and the stroke amount of the movable portion 10 in the advancing and retracting directions increases and the writability deteriorates when only the soft cushioning material is provided, which is the same as the above. In the present embodiment, the operation of pressing the switch does not occur. Thus, even if the stroke amount of the movable portion increases, the difference between the timing at which the contact member contacts the display face and the timing at which an image is written on the display face does not increase. However, when the pushing of the movable portion is increased at the time of writing, the operation amount by the pen-type input device at the time of writing is increased by that amount, and the writability deteriorates. Therefore, by providing the first cushioning material 14 and the second cushioning material 15 having different stiffnesses, both excellent writability and reduction in writing sound can be achieved.

Also, in the pen-type input device 1 of the present embodiment, the above-described configuration can be appropriately operated. Specifically, the first cushioning material 14 having low stiffness may be provided on the tip side of the pen-type input device 1 as illustrated in FIG. 6, the thickness of the first cushioning material 14 having low stiffness in the advancing and retracting directions may be smaller than the thickness of the second cushioning material 15, or three or more cushioning materials may be provided as illustrated in FIG. 5. Accordingly, the same effects as those of the above-described embodiment can be obtained.

### Fourth Embodiment

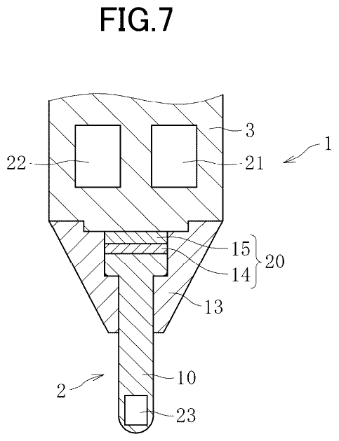

Another embodiment of the present disclosure is also applicable to a pen-type input device that performs position detection by a capacitance method. For example, the pen-type input device 1 illustrated in FIG. 7 is different from the pen-type input device 1 illustrated in FIGS. 3 and 6 in that an electric field generator 23 is provided on the tip side of the movable portion 10, and a battery 21, a controller 22, and the like are provided inside. A tablet personal computer (PC) using the pen-type input device 1 includes a touch panel that performs position detection by a capacitance method corresponding to the pen-type input device 1.

Also, in the pen-type input device 1 of the present embodiment, the writing sound increases when only the hard cushioning material is provided, and the stroke amount of the movable portion in the advancing and retracting directions increases and the writability deteriorates when only the soft cushioning material is provided, as in the above case. Therefore, by providing the first cushioning material 14 and the second cushioning material 15 having different stiffnesses, both the excellent writability and the reduction in writing sound can be achieved.

In addition, in the present embodiment, a so-called active capacitive pen-type input device that performs writing using an electric field generated by the electric field generator 23 is illustrated, but the present embodiment can also be applied to a passive capacitive pen-type input device.

### [Educational System To Which Pen-Type Input Device Is Applied]

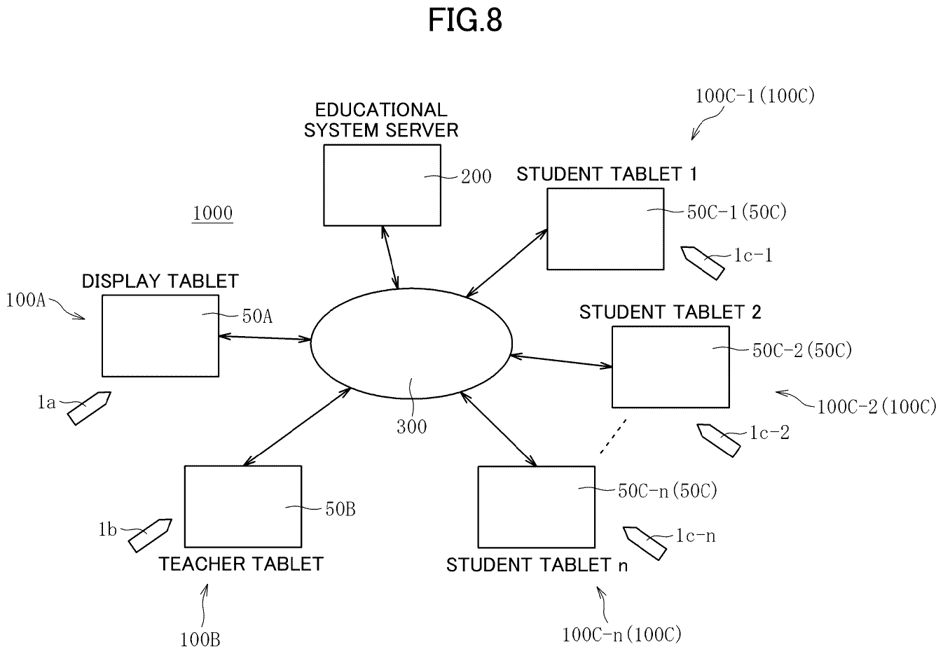

A case where the pen-type input device 1 of the above embodiment is applied to an educational system which is an example of a communication system will be described with reference to FIG. 8.

FIG. 8 illustrates a system configuration of an educational system 1000. The educational system 1000 includes a plurality of display devices 100A, 100B, and 100C (100C-1 to 100C-n: n is a positive integer), and an educational system server 200 that is a server. The display device 100A includes a display tablet 50A as a display portion and a pen-type input device 1a. The display device 100B includes a teacher tablet 50B as a display portion and a pen-type input device 1b. Each display 100C is provided with a student tablet 50C as a terminal or a display portion, and a pen-type input device 1a. The tablet 50A, 50B, 50C, and the educational system server 200 are connected via a network 300.

The educational system server 200 stores class identification information, information on students of the class (names, IDs, and the like), a class lesson timetable and a teacher in charge, textbook data for each subject, and class lesson progress information for each class and each subject (how many pages of the textbook have been learned until the previous class, availability and content of homework, and the like), determines a subject from the class identification information and the timetable based on the day of the week and the time of day, and provides information related to the class of the subject.

The teacher tablet 50B is a tablet used by a teacher who teaches a class, and is used to retrieve necessary information (e.g., a textbook of a subject to be given to a class, a practice question, and a model answer) from the educational system server 200, turn a page of a displayed textbook, and designate a student who answers a question. The pen-type input device 1b can be used to write on the teacher tablet 50B.

The student tablet 50C is a tablet used by a student, and can display a textbook downloaded from the educational system server 200, and can display the contents written by a teacher on the display tablet 50A or the teacher tablet 50B. Further, the student can write answers to questions on the student tablet 50C by using the pen-type input device 1c and upload the answers to the educational system server 200.

The pen-type input device 1a can write on the display tablet 50A. The display tablet 50A has the configuration as illustrated in FIG. 2, and implements the functions necessary for the educational system by installing the application of the educational system in the controller 51 and activating the application. The display tablet 50A can display the contents written by the teacher on the teacher tablet 50B, or can display the contents written on a specific student tablet 50C by the teacher's operation on the display tablet 50A or the teacher tablet 50B.

The teacher tablet 50B and the student tablet 50C are ordinary tablet PCs, and each of these tablets includes a CPU, a memory, a wireless interface, a display portion, and the like. The CPU activates the educational system application installed in the memory to implement the functions necessary for the educational system as described above. Also, the teacher tablet 50B and the student tablet 50C are connected to the educational system server 200 via the network 300 by a wireless interface and can communicate with each other.

The teacher tablet 50B and the student tablet 50C adopt a capacitance method as an example for position detection of the pen-type input device. In addition, the display tablet 50A adopts an infrared detection method as an example for detecting the position of the pen-type input device.

Since the display tablet 50A uses the infrared method and tablets 50B and 50C use the capacitance method to detect the positions of pen-type input devices 1a, 1b, and 1c-1 to 1c-n, the pen-type input devices 1a, 1b, and 1c-1 to 1c-n are pen-type input devices configured to handle the respective position detection methods. However, the present disclosure is not limited to this example, and by adopting the configuration of the present disclosure in any pen-type input device, it is possible to achieve both smooth communication with excellent writability and reduction of noise during writing, and it is possible to provide a comfortable class environment.

In this embodiment, the student tablet 50C has the configuration of the display portion of the present disclosure that allows writing with the pen-type input device 1c, and also has the configuration of the terminal of the present disclosure that displays the contents written on the display tablet 50A or the teacher tablet 50B. However, the student tablet 50C may be a device that simply displays the contents written on the display tablet 50A or the teacher tablet 50B. By configuring the student tablet 50C as a display portion on which writing can be performed by the pen-type input device 1c, similarly to the display tablet 50A and the like, mutual communication between the teacher and the student can be more smoothly performed. In this case, since writing is performed by a plurality of pen-type input devices, it is preferable to reduce noise by applying the pen-type input device of the embodiment to the plurality of pen-type input devices. Further, although the configuration of the display portion of the embodiments of the present disclosure is adopted for the display tablet 50A, a display may be used which simply displays the contents written on the teacher tablet 50B or the student tablet 50C.

In the present embodiment, an educational system used in an educational site is illustrated as an example of a communication system to which the pen-type input device of the present disclosure is applied, but the present disclosure is not limited to this example. For example, the pen-type input device of the present disclosure may be applied to a conference management system as a communication system. Accordingly, it is possible to achieve both smooth communication with excellent writability and reduction of noise during writing, and to provide a comfortable conference environment.

Although the embodiments of the present disclosure have been described above, the present disclosure is not limited to the above-described embodiments, and it is needless to say that various modifications can be made without departing from the gist of the present disclosure.

The display device of the present disclosure is not limited to the configuration in which the position of the display portion with which the writing device is in contact is filled in. Conversely, the display device may include a writing device configured to erase the display of the contact position (to change the color of the display to the same color as the background of the display face), or a writing device capable of both filling in and erasing. In this way, the case where the display is turned off (the color is made the same as the background of the display face) is also included in the “writing” of the present disclosure.

The aspects of the present disclosure are, for example, as follows.

<1>

A writing device includes:
a movable portion having a contact portion, the movable portion being configured to be movable in advancing and retracting directions so as to be retracted when the contact portion comes into contact with a contact target portion;
a holding portion configured to hold the movable portion; and
an elastic portion provided on a side opposite from a contact portion side of the movable portion in the advancing and retracting directions,
wherein the elastic portion includes a first elastic body and a second elastic body, the first elastic body and the second elastic body each being elastically deformed by retraction of the movable portion to reduce a thickness in the advancing and retracting directions,
wherein the first elastic body and the second elastic body are provided adjacent to each other in this order with respect to the movable portion, and
wherein the first elastic body is an elastic body having stiffness lower than stiffness of the second elastic body.
   <2>

The writing device according to <1>, wherein the first elastic body has a thickness in the advancing and retracting directions smaller than a thickness of the second elastic body.

<3>

The writing device according to <2>,
wherein the first elastic body is a sponge, a thickness of the first elastic body in the advancing and retracting directions is 0.5 to 1.0 mm, and sponge stiffness of the first elastic body is 10 to 20, and
wherein the second elastic body is a rubber, a thickness of the second elastic body in the advancing and retracting directions is 1.5 to 2.5 mm, and rubber stiffness of the second elastic body is 50 to 60.
   <4>

The writing device according to <2>,
wherein the first elastic body is a rubber, a thickness of the first elastic body in the advancing and retracting directions is 0.5 to 1.0 mm, and rubber stiffness of the first elastic body is 5 to 15, and
wherein the second elastic body is a rubber, a thickness of the second elastic body in the advancing and retracting directions is 1.5 to 2.5 mm, and rubber stiffness of the second elastic body is 50 to 60.
   <5>

A writing device including:
a movable portion having a contact portion, the movable portion being configured to be movable in advancing and retracting directions so as to be retracted when the contact portion comes into contact with a contact target portion;
a holding portion configured to hold the movable portion; and
an elastic portion provided on a side opposite from a contact portion side of the movable portion in the advancing and retracting directions,
wherein the elastic portion includes a first elastic body, a second elastic body, and one or a plurality of other elastic bodies, the first elastic body, the second elastic body, and the one or the plurality of other elastic bodies each being elastically deformed by retraction of the movable portion to reduce a thickness in the advancing and retracting directions, and
wherein the first elastic body, the one or more other elastic bodies, and the second elastic body are provided adjacent to each other in this order with respect to the movable portion, and stiffnesses of the first elastic body, the one or more other elastic bodies, and the second elastic body increase in this order.
   <6>

The writing device according to <5>, wherein the first elastic body has a thickness in the advancing and retracting directions smaller than a thickness of the second elastic body.

<7>

The writing device according to <6>,
wherein the first elastic body is a sponge, a thickness of the first elastic body in the advancing and retracting directions is 0.5 to 1.0 mm, and sponge stiffness of the first elastic body is 10 to 20, and
wherein the second elastic body is a rubber, a thickness of the second elastic body in the advancing and retracting directions is 1.5 to 2.5 mm, and rubber stiffness of the second elastic body is 50 to 60.
   <8>

The writing device according to <6>,
wherein the first elastic body is a rubber, a thickness of the first elastic body in the advancing and retracting directions is 0.5 to 1.0 mm, and rubber stiffness of the first elastic body is 5 to 15, and
wherein the second elastic body is a rubber, a thickness of the second elastic body in the advancing and retracting directions is 1.5 to 2.5 mm, and rubber stiffness of the second elastic body is 50 to 60.
   <9>

The writing device according to any one of <1> to <8>, further including:
a pressing portion configured to be pressed by the movable portion moving in a retracting direction of the advancing and retracting directions,
wherein a signal is output by pressing of the pressing portion.
   <10>

A display device including:
the writing device according to any one of <1> to <9>; and
a display portion as the contact target portion,
wherein the display portion detects a contact position of the contact portion with respect to the display portion, and performs a predetermined display.
   <11>

A communication system including:
one or a plurality of display devices each including the writing device according to any one of <1> to <9>, and a display portion as the contact target portion;
a plurality of terminals configured to perform a predetermined display; and
a server,
wherein the display device, the plurality of terminals, and the server are communicably connected to each other,
wherein the display device detects a contact position of the contact portion with respect to the display portion, and performs a predetermined display, and
wherein the terminals display a content of writing on the display portion of the display device by the writing device.
   <12>

The communication system according to <11>, wherein each of the terminals displays a content of writing on a corresponding one of the terminals by the writing device.

What is claimed is:

1. A writing device comprising:
a movable portion having a contact portion, the movable portion being configured to be movable in advancing and retracting directions so as to be retracted when the contact portion comes into contact with a contact target portion;
a holding portion configured to hold the movable portion; and
an elastic portion provided on a side opposite from a contact portion side of the movable portion in the advancing and retracting directions,
wherein the elastic portion includes a first elastic body and a second elastic body, the first elastic body and the second elastic body each being elastically deformed by retraction of the movable portion to reduce a thickness in the advancing and retracting directions,
wherein the first elastic body and the second elastic body are provided adjacent to each other in this order with respect to the movable portion, and
wherein the first elastic body is an elastic body having stiffness lower than stiffness of the second elastic body.

2. The writing device according to claim 1, wherein the first elastic body has a thickness in the advancing and retracting directions smaller thana thickness of the second elastic body.

3. The writing device according to claim 2,
wherein the first elastic body is a sponge, a thickness of the first elastic body in the advancing and retracting directions is 0.5 to 1.0 mm, and sponge stiffness of the first elastic body is 10 to 20, and
wherein the second elastic body is a rubber, a thickness of the second elastic body in the advancing and retracting directions is 1.5 to 2.5 mm, and rubber stiffness of the second elastic body is 50 to 60.

4. The writing device according to claim 2,
wherein the first elastic body is a rubber, a thickness of the first elastic body in the advancing and retracting directions is 0.5 to 1.0 mm, and rubber stiffness of the first elastic body is 5 to 15, and
wherein the second elastic body is a rubber, a thickness of the second elastic body in the advancing and retracting directions is 1.5 to 2.5 mm, and rubber stiffness of the second elastic body is 50 to 60.

5. A writing device comprising:
a movable portion having a contact portion, the movable portion being configured to be movable in advancing and retracting directions so as to be retracted when the contact portion comes into contact with a contact target portion;
a holding portion configured to hold the movable portion; and
an elastic portion provided on a side opposite from a contact portion side of the movable portion in the advancing and retracting directions,
wherein the elastic portion includes a first elastic body, a second elastic body, and one or a plurality of other elastic bodies, the first elastic body, the second elastic body, and the one or the plurality of other elastic bodies each being elastically deformed by retraction of the movable portion to reduce a thickness in the advancing and retracting directions, and
wherein the first elastic body, the one or more other elastic bodies, and the second elastic body are provided adjacent to each other in this order with respect to the movable portion, and stiffnesses of the first elastic body, the one or more other elastic bodies, and the second elastic body increase in this order.

6. The writing device according to claim 1, further comprising:
a pressing portion configured to be pressed by the movable portion moving in a retracting direction of the advancing and retracting directions,
wherein a signal is output by pressing of the pressing portion.

7. A display device comprising:
the writing device according to claim 1; and
a display portion as the contact target portion,
wherein the display portion detects a contact position of the contact portion with respect to the display portion, and performs a predetermined display.

8. A communication system comprising:
one or a plurality of display devices each including the writing device according to claim 1, and a display portion as the contact target portion;
a plurality of terminals configured to perform a predetermined display; and
a server,
wherein the display device, the plurality of terminals, and the server are communicably connected to each other,
wherein the display device detects a contact position of the contact portion with respect to the display portion, and performs a predetermined display, and
wherein the terminals display a content of writing on the display portion of the display device by the writing device.

9. The communication system according to claim 8, wherein each of the terminals displays a content of writing on a corresponding one of the terminals by the writing device.
